(19) United States
(12) Patent Application Publication
(10) Pub. No.: US 2005/0192939 A1
(43) Pub. Date: Sep. 1, 2005

(54) System and method for providing classification security in a database management system

(75) Inventors: Paul M. Bird, Markham (CA); Walid Rjaibi, Markham (CA)

Correspondence Address: INTERNATIONAL BUSINESS MACHINES CORPORATION (SRM), INTELLECTUAL PROPERTY LAW DEPARTMENT, 555 BAILEY AVENUE J46/G4, SAN JOSE, CA, 95141, US

(73) Assignee: International Business Machines Corporation, Armonk, NY (US)

(21) Appl. No.: 10/788,515

(22) Filed: Feb. 27, 2004

(51) Int. Cl. G06F 17/30

(52) U.S. Cl. 707/3

(57) ABSTRACT

In accordance with one aspect of the present invention, there is provided a system and method for providing classification security in a database management system, in which the database management system operates cooperatively with an external classification engine. A classified table with declared interactions with the external classification engine is employed. A statement containing a request for access to data stored in the classified table is compiled into executable instructions. When these instructions are executed, the external classification engine is invoked that generates an indicator of whether a user is to be permitted access to data stored in each of one or more rows of the classified table, by comparing one or more classifications associated with the user to a classification derived from data stored in each respective row. The indicator is returned to the database management system and used to determine what rows of data are to be retrieved from the classified table.

### FIELD OF THE INVENTION

The present invention relates generally to database management systems, and more specifically to systems and methods for providing classification or label security for database management systems.

### BACKGROUND OF THE INVENTION

Classification security (also referred to as “label security” or “label-based access control”, for example) is a term used to describe a type of mechanism used in relational database management systems (RDBMS) to control access to data in a database. Typically, a classification (or “label”) stored in the rows of one or more data tables is compared to one or more classifications assigned to the user attempting access to the rows. A user who requests access to the contents (i.e. the data) in one or more rows of the data tables may also be referred to more generally as the “requester”. The classification stored in and associated with each row provides information about the classification or sensitivity of the data in that row. Accordingly, different classifications may be assigned to different users to control which rows of data each particular user may access. The two classifications are compared in accordance with a classification scheme or a predefined set of classification rules, to determine which users can access which rows of data. Various classification schemes and rules (also referred to more generally as “classification methodologies”) are known in the art, and can be customized as desired.

Current implementations of classification security in RDBMS often make two assumptions that are not always true. First, it is typically assumed that the classification associated with a particular data table row is explicitly stored in the data row for later retrieval. However, existing databases may not employ classifications within the rows of their data tables, and it may neither be preferable nor desirable (e.g. due to cost and storage space considerations) to modify existing tables to incorporate classifications into the data.

Second, it is typically assumed that the RDBMS is the sole repository of all user and data classifications. However, a RDBMS often exists as only one part of a larger overall system or network having many other components, applications or products. Requiring the RDBMS to be the sole repository of all associated user and data classifications limits the ability of the RDBMS to be integrated with other components of the overall network, which may employ their own classification security system. Potentially, one classification methodology might be employed for use with the RDBMS while a different classification methodology may apply to the rest of the network. At best, the user of the system will have to maintain the classification mechanisms used in two different places (the network and the RDBMS) and ensure that the two mechanisms provide equivalent results, in order to ensure that a consistent level of security is applied across the system.

### SUMMARY OF THE INVENTION

In one aspect, the present invention is directed to an improved system and method for providing classification security in a database management system that overcomes at least some of the disadvantages of the prior art implementations described above.

In another aspect, the present invention relates to a system and method for providing classification security in a database management system, where the database management system operates cooperatively with a classification engine external to the database management system, such that pervasive overall system or network coverage may be provided using a common classification methodology. For example, access control to data after it has left the database management system may still be enforced by other components of the overall system or network using the same classification methodology.

In another aspect of the present invention, a classified table with declared interactions with the external classification engine is employed. A statement containing a request for access to data stored in the classified table is compiled into executable instructions. When these instructions are executed, the external classification engine is invoked. The external classification engine is asked to generate an indicator of whether the requester is to be permitted access to data stored for each of one or more rows of the classified table, by comparing one or more classifications associated with the user as determined by the external classification engine to the classification determined by the same external engine for each respective row. This indicator is returned to the database management system, and used to determine which rows of the classified table may be accessed by this user.

In another aspect of the present invention, there is provided, for a data processing system comprising a database, the database comprising classified table elements, the data processing system coupled to a classification engine adapted to provide indicators of approval or non-approval to permit, for a request associated with a requester, access to contents of the classified table elements, a method for retrieving data from the classified table elements, the method comprising the steps of: receiving the request, from the requester, to access the contents of the classified table elements; for each classified table element, asking the classification engine to provide an indication of whether the requestor associated with the request is to be permitted access to the contents of the respective classified table element; and accessing the contents of each classified table element for which an approval indicator is received from the classification engine, the approval indicator indicating that the requestor is permitted to access the contents of the respective classified table element; wherein the asking step comprises sending the request to the classification engine coupled to the data processing system.

Instructions for performing the steps of a method for retrieving data from the classified table element in an embodiment of the present invention may be stored on a computer-readable medium.

In another aspect of the present invention, there is provided a data processing system comprising a database, the database comprising classified table elements, the data processing system coupled to a classification engine adapted to provide indicators of approval or non-approval to permit, for a request associated with a requester, access to contents of the classified table elements, the data processing system comprising one or more modules programmed to perform the steps of: receiving the request, from the requester, to access the contents of the classified table elements; for each classified table element, asking the classification engine to provide an indication of whether the requestor associated with the request is to be permitted access to the contents of the respective classified table element; and accessing the contents of each classified table element for which an approval indicator is received from the classification engine, the approval indicator indicating that the requester is permitted to access the contents of the respective classified table element; wherein the asking step comprises sending the request to the classification engine coupled to the data processing system.

### BRIEF DESCRIPTION OF THE DRAWING

For a better understanding of the present invention and to show more clearly how it may be carried into effect, reference will now be made, by way of example, to the accompanying drawings, which are referenced in the foregoing description to illustrate embodiments of the present invention, and in which:

FIG. 1 is a schematic diagram of a typical database management system in one example implementation of the present invention; and

FIG. 2 is a flowchart illustrating steps in a method of providing classification security in a database management system in an embodiment of the present invention.

### DETAILED DESCRIPTION OF THE INVENTION

The present invention relates generally to data processing systems known as database management systems, and more specifically to systems and methods for providing classification or label security for database management systems. In the foregoing description, the invention is described with respect to a relational database management system (RDBMS). However, it will be understood by persons skilled in the art that certain features of the present invention can also be applied to other database management systems.

The present invention provides a classification security system and method for use with a database management system, which integrates an external classification engine directly into the database management system in order to provide pervasive system coverage. The invention provides an efficient, integrated means of achieving such coverage, unlike some prior art solutions where complex wrappers around the database management system that operate external to the database management system and work by intercepting requests prior to their presentation to the database management system. These solutions generally do not achieve high levels of performance and are relatively difficult to develop and maintain, as they require a detailed understanding of the nature and semantics of each request that is typically only known by the database management system itself.

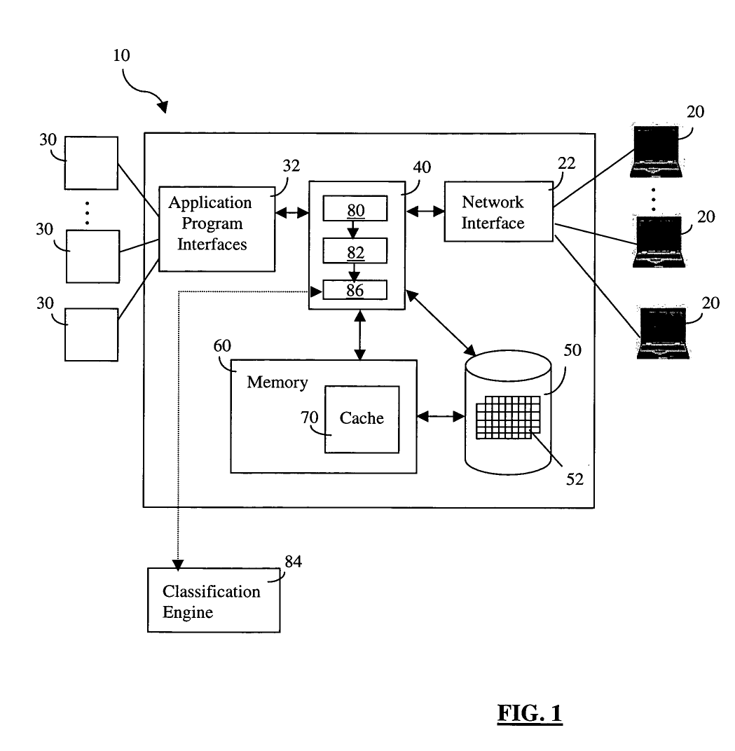

Referring to FIG. 1, a schematic diagram of a typical relational database management system is shown generally as 10, in one example implementation of the present invention. Database systems are available on computing machines of varying sizes. For example, RDBMS 10 is shown in FIG. 1 as a multi-user system, which is generally employed on larger computing machines. In the example implementation shown, multiple users 20 may access RDBMS 10 through a network interface 22, through an application program [not shown] interacting with users 20, for example. Other types of application programs 30 (e.g. autonomous programs) may also be provided access to RDBMS 10 through a set of application program interfaces 32. At least one processor 40 is coupled to network interface 22 and application program interfaces 32 to provide and control access to data in a physical database 50 by users (i.e. users 20 and/or application programs 30 referred to collectively, in this example).

In this example implementation of RDBMS 10, data is stored in one or more data tables 52 in database 50. Data pertaining to a particular record is stored in a table element such as a row of data table 52, with individual data items of the respective record being stored in the columns of data table 52; in that case, each column corresponds to a defined field.

In the environment of RDBMS 10, numerous software execution units (processes or threads) concurrently perform the work that is necessary to service user requests. The servicing of requests typically involves finding and retrieving data from a physical disk (i.e. database 50) for storage in a memory 60 of RDBMS 10. Data may be loaded into a cache store 70 of memory 60 to enhance performance, in known manner. Data retrieved from database 50 and stored in memory 60 in response to a request may then be returned to the user issuing the request, typically after some further processing by processor 40, to provide the data to the user in an appropriate or desired format, for example.

More specifically, in accordance with this example implementation, a request is in the form of a structured query language (SQL) statement, which references a data table 52 in database 50. The SQL request is received by an SQL compiler module 80, which operates to compile the request into a set of executable instructions. These instructions are then passed to an SQL runtime module 82, which executes the instructions generated by SQL compiler module 80. When these instructions are executed, the requested data is retrieved from the appropriate data table 52 in database 50 and returned to the user (e.g. a user 20 or application program 30) issuing the request. The user making the data request is also referred to herein in the description and in the claims more generally as a “requester”.

In accordance with the present invention, at least one data table 52 in database 50 is declared as classified. A data table 52 can be declared as classified by marking the table as classified during the creation of the table by a user, or by modification of the appropriate attributes of an existing table, for example. When a data table 52 is made classified, the method of determining the classification level (also referred to as “classification” or “label”) associated with each row of the data table 52 is specified. This information is stored in the system catalog [not shown] for later reference when access to the data table 52 is attempted.

In this embodiment of the invention, each row of the classified data table 52 represents a data record. In the specification and in the claims, each row of the classified data table 52 may be referred to more generally as a “classified table element”. When a requester makes a request to access the contents of a particular data record, the requester is considered to be making a request to access the contents of a specific classified table element, namely the associated row of the classified data table 52 in this case. It will be understood by persons skilled in the art that in a typical RDBMS, the “classified table element” will typically be a data row in a table that has been declared as classified. However, in variant embodiments of the invention, a classified table element might be some other element that represents a data record in a database management system.

Once a data table 52 has been declared as classified, RDBMS 10 can now implement an extra level of access control using the specified classification method, to ensure that the classification level associated with each of row of the data table 52 is compatible with a user classification level (also referred to herein as “user classification” and “requester classification”) associated with any particular user. It will be understood by persons skilled in the art that a classification associated with a data table row may also be referred to as a “row label”, whereas a classification associated with a user may also be referred to as an “access label”. Other terminology may also be used in the art to describe these elements.

In accordance with an embodiment of the present invention, RDBMS 10 operates cooperatively with a classification engine 84 external to RDBMS 10. External classification engine 84 can be coupled to one or more storage elements [not shown]. In this embodiment, external classification engine 84 manages data and performs a number of functions related to a classification methodology outside of RDBMS 10. For example, external classification engine 84 may maintain label definitions, assigns labels to both users and data rows, maintain rules for label comparison, and implement decision-making logic used to compare one label to another in access requests. The external classification engine 84 may also be referred to herein more generally as a classification engine.

It will be understood by persons skilled in the art that while the classification method is performed outside of the RDBMS 10, both RDBMS 10 and external classification engine 84 may still physically (although not necessarily) reside on the same server or computing machine.

In one embodiment of the invention, the external classification engine 84 is programmed to implement classification security and assign user classification or requester classification levels and classifications associated with rows of data table 52. When a data table 52 is made classified, it is decided whether classification security is to be implemented within RDBMS 10, or alternatively, by external classification engine 84 in accordance with the present invention. However, in both cases, enforcement of row access control is handled by RDBMS 10 during execution of statements that require the classified data table 52 to be accessed, such that after the access label(s) associated with the user are compared to the label assigned to a particular row, the RDBMS 10 ensures that the result of the comparison is respected in terms of whether that user will have access to that row.

It may be advantageous for an RDBMS to be integrated with an external classification engine for a number of reasons. For example, integrating an external classification engine with an RDBMS may permit easier administration of labels and label access rules. Some third-party classification engines have strong expertise in this area and offer a number of tools for managing labels and label access rules. Such integration may also increase the flexibility and diversity of decision mechanisms used in classification security systems. This may also facilitate integration of the RDBMS into enterprise environments, in which a central or end-to-end system for label management already exists or is to be implemented.

The classification methodologies to be applied with respect to a classified table in RDBMS 10 but reliant on external classification engine 84 for label definitions, label access rules, and label comparison decisions will cover not only the scenario in which a classification level associated with a particular row of data table 52 is explicitly contained in one or more columns of that row, but also the scenario where the data table 52 does not explicitly contain the classification level associated with the particular row.

In order to accommodate the latter scenario, external classification engine 84 is programmed to derive a classification level that applies to a particular row in accordance with a defined algorithm based on the data in one or more classification columns of classified data table 52. The classification columns comprise a subset of columns of a classified data table 52; the data in these classification columns are passed to external classification engine 84 as arguments to input classification parameters from which the classification level associated with the rows of data table 52 may be derived using the algorithm. This set of columns may also be referred to as a mapping set, and the algorithm may also be referred to as a column mapping scheme.

Since the task of determining the classification level associated with particular rows of data table 52 is being deferred to an engine outside of RDBMS 10, it is not necessary to modify existing data tables by storing labels, explicitly in additional columns to implement classification security on an existing database as long as a classification level can be derived from data in existing columns of the data tables in that database.

The following code illustrates in one example implementation, how a classified data table 52 may be created that would interact with an external classification engine 84:

```
>>--CREATE TABLE--<existing syntax>--+-------------------------------+------><
                                                                          ′-- classification-attributes --′
classification-attributes
>>--CLASSIFIED BY--+--SYSTEM |system-clause|-----+-----><
                                      ′--EXTERNAL|external-clause|--′
system-clause
|--LABEL SET--label-set-name--LABEL--+---------ROW----------+-------|
                                                                          ′--|generated-clause|--′
external-clause
|--LABEL ROW--|
generated-clause
                                            .--,------------.
                                            V |
|--GENERATED USING (--+--column-name--+--)--MAPPING--|mapping-clause|--|
mapping-clause
            .--,-------------.
            V |
|--(--+--column-value--+--)--TO--label--|
```

A data table can also be made classified by altering the table and modifying the appropriate parameters. Some of the syntactical terms used in the above example implementation are described in further detail below:
CLASSIFIED BY SYSTEM: Specifies that this is a classified table where the label set and the label access rules are defined within the RDBMS.
CLASSIFIED BY EXTERNAL: Specifies that this is a classified table where the label set and the label access rules are defined outside the RDBMS within an external classification engine (e.g. third-party security engine), in accordance with the present invention.
LABEL SET label-set-name: Specifies the label set name for a classified table classified by the RDBMS. This is not applicable for a classified table classified by external, as in that case (as explained earlier with respect to at least one embodiment of the invention), the labels and the label access rules are defined and managed outside the RDBMS by the external classification engine. The label set name must identify a label set name that already exists. An error is returned otherwise.
LABEL ROW: Indicates that the label associated with a data row from the classified table is to be stored within the data row itself. When the table is classified by the system, the RDBMS chooses an appropriate column type and length to store the row label (or simply its id). When the table is classified in cooperation with an external engine, a call to the external classification engine is made through a well-defined user-exit to obtain the column type and length information before creating the table in one embodiment of the invention.

The syntax described above is for one example implementation in which both an external classification system and a classification system residing in RDBMS 10 can be supported. However, this is provided by way of example only. The syntax may be different in variant implementations. For example, the syntax can be extended or modified to accommodate other classification security solutions such as a label solution only implemented completely within RDBMS 10 by providing the classification methodology within RDBMS 10 itself, or to provide a label solution with an external classification where the label value is solely derived from column values via a form of the above mapping scheme (i.e. to handle the scenario where the row label value is not stored in the row). Various hybrid approaches are also possible, in which subsets of various classification information associated with the user (or requestor) and/or data rows (or classified table elements) are stored or shadowed in RDBMS 10 for performance reasons. For example, in implementing these approaches, the external classification engine 84 may only be called when required, and only to obtain specific information not otherwise stored in RDBMS 10 (e.g. to reduce the overhead of calling external classification engine 84).

In typical operation of RDBMS 10, SQL compiler module 80 receives a SQL statement as input. The SQL statement may require that data in data table 52 be accessed. SQL compiler module 80 is programmed to analyze an SQL statement and generally determine the most efficient method of satisfying that statement at execution time. The output from SQL compiler module 80 is an executable form of the SQL statement received. SQL runtime module 82 then typically takes this executable form of the SQL statement and uses it to run the statement until completion, with the results being returned to the user.

In accordance with an embodiment of the present invention, the logic within SQL compiler module 80 is modified to perform additional steps when producing the executable form of SQL statements, in order to accommodate the existence of classified data tables. When a classified data table 52 is referenced in an SQL statement received as input, SQL compiler module 80 will determine if classification security is to be implemented by an external classification engine 84. Added instructions are then provided in the executable form of the SQL statement generated by SQL compiler module 80 (the executable form of the SQL statement is also referred to herein as a “section”), to be subsequently executed by SQL runtime module 82.

The added instructions are in the form of new logic that is added to the section for any access to a classified data table 52 in order to interact with the external engine 84 and to enforce the decision of the external engine 84. These added instructions can be implemented in the form of a new access evaluation operator for example, included as part of the section to perform these functions, where the term “evaluation operator” is defined broadly as one or more logic elements in the executable form of the SQL statement. Alternatively, the new logic may be implemented within a normal procedure call, or directly implemented within the section, for example.

The access evaluation operator integrates the call to the external classification engine 84 and implements the call to the external classification engine 84 through a routine called by an instruction in the section. As described below with respect to variant embodiments of the invention, the access evaluation operator may also integrate calls to a decision cache and/or processing exits in the section.

The access evaluation operator is defined such that when the (compiled) SQL statement is executed by SQL runtime module 82, relevant data from a particular row of the classified table (e.g. either labels or data used to derive a label for the row) and relevant user authorization information is passed to the operator. The access evaluation operator will direct RDBMS 10 to invoke external classification engine 84 and pass the relevant data as arguments to the classification parameters required by the external classification engine 84. The SQL compiler module 80 identifies the type of information that will need to be obtained and passed to external classification engine 84; the SQL runtime module 82 gets the actual values and executes the actual invocation of the external classification engine 84.

Arguments to the classification parameters passed to external classification engine 84 may include information about the various authorization IDs associated with the current request (e.g. SQL statement) from which a user or requestor classification, or access label, can be determined by the external classification engine 84. For example, this information may include the current authorization identifier (ID) in use for the request at the time of execution, the current session authorization ID, and the authorization ID used to establish the connection to RDBMS 10. External classification engine 84 can use one or all of these pieces of information to determine the relevant access label for the requestor; the assignment of access labels to specific users can be handled in any manner as needed by external classification engine 84 and is done independent of RDBMS 10.

As indicated above, arguments to the classification parameters to be passed to external classification engine 84 will also typically include the data values in each of the identified classification columns associated with the classified data table 52. The data values in the classification columns may be a label if labels are stored directly in classified data table 52, or they may be data used by the external classification engine 84 to derive a label using a column mapping scheme where labels are not stored directly in classified data table 52.

Other information may also be passed as arguments to the classification parameters required by the external classification engine 84 during execution of the SQL statement. For example, the source of the SQL statement may be passed to provide specific context information to external classification engine 84. In variant embodiments of the invention, the arguments to the classification parameters may identify an external source of information or engine that may be accessed to obtain user or requestor classifications for use by external classification engine 84, to provide for increased flexibility. In any event, the specific requisite information to be passed to external classification engine 84 will depend on the particular implementation. In one flexible implementation, when the table is indicated within RDBMS 10 as being classified by an external classification engine or system, the external classification engine or system is invoked by RDBMS 10 and requested to indicate what information it requires from RDBMS 10 in order to provide its classification services. This information could cover authorization ID, data, or even other RDBMS information.

At execution time, SQL runtime module 82 follows the processing steps as outlined in the executable form of the SQL statement (which contains the added instructions) as generated by SQL compiler module 80. In accordance with the present invention, SQL runtime module 82 is programmed to accommodate and execute the added calls to external classification engine 84. For example, external classification engine 84 can be called to determine if the authorization ID executing the statement is allowed to access individual rows of classified data table 52. For each row of classified data table 52, external classification engine 84 may be programmed to return an approval indicator or non-approval indicator, which indicates whether the requestor requesting access to the data stored in the respective row is permitted access to that data. For example, a boolean “yes/no” indicator or reply, for each row, is returned to the caller, where the indicator indicates whether data in a particular row is eligible for access to the requester or not. As a result, when retrieving data from classified data table 52 of database 50, a row may then be bypassed if a “no” indicator is returned by external classification engine 84. Processing of subsequent rows continues, with repeated calls to external classification engine 84 being made. In one embodiment of the invention, the external classification engine 84 is asked to generate an indicator for each row of the classified data table 52, one row per invocation of the engine. In variant embodiments of the invention, the external classification engine 84 may be asked to provide multiple indicators for multiple rows per invocation of the engine.

In one embodiment of the present invention, SQL runtime module 82 co-operates with one or more processing exits 86 to facilitate integration of RDBMS 10 with external classification engine 84. In this case, SQL runtime module 82 does not call external classification engine 84 directly, but through a processing exit 86, which act as an interface to external classification engine 84. This can better facilitate integration of RDBMS 10 with existing third-party external classification engines and/or multiple external classification engines, for example. Processing exits 86 control how and when an external classification engine 84 is invoked, and can be modified for different desired implementations.

For example, a system integrating RDBMS 10 and external classification engine 84 utilizes, at strategic processing points, processing exits 86 provided as code exits and/or SQL routine exits, for example. In this example implementation, processing exits 86 may be used by RDBMS 10 to request external classification engine 84 to provide the following services as required, for example:
determine a classification level for a particular row, e.g., given the data values stored in the classification columns according to the classification column mapping scheme for that table;
determine one or more classifications available for a requester, e.g. for a given authorization ID; and
compare the requestor classification level with the classification associated with a row to see if they are compatible given the access being attempted (e.g. read, write), and generate an indicator of approval or non-approval as described herein.

Processing exits 86 may also perform other functions, such as validating that data values in classification columns of a data table 52 may be properly mapped to a classification level, for example. It will be apparent to those skilled in the art that the services provided by the external classification engine can also be offered together in various combinations within any particular processing exit offered by the RDBMS as desired by the particular implementation.

In a variant embodiment of the present invention, SQL runtime module 82 can implement a form of decision caching to achieve more efficient performance throughput. Decisions (e.g. returned “yes/no” indicators) received from external classification engine 84 in response to a particular set of arguments for the input classification parameters passed to the external classification engine may be cached for subsequent use. The cached decisions may be allowed to last for the duration of the current statement execution, the transaction, or the connection, for example, as may be determined acceptable for a particular implementation. Accordingly, before external classification engine 84 is called, the cached decisions (e.g. which may be stored in cache 70, elsewhere in memory 60, or in a separate storage device or memory) may be checked to see if a decision by external classification engine 84 had previously been made based on a given set of arguments to the input classification parameters. If so, the cached decision can be returned to the caller (i.e. the executing thread) and used in lieu of calling external classification engine 84. At the end of the duration, the cached decisions may be freed or invalidated; invalidating cached decisions may result in improved performance in some implementations, as the invalidated entries could be reused, thus avoiding costs associated with memory allocation and de-allocation.

The structure of the decision cache used in this variant embodiment of the invention can be implemented in a number of ways. For example, a simple way that allows for different authorizations to be used for SQL statements is one that has the first layer of addressing based on the unique authorization IDs followed by a second layer based on unique classification column values for each row. Both layers may be implemented using hash tables or linked lists, for example. If only statement level caching is desired, then only the unique classification column values for each row may be cached as authorization information for a statement is typically not allowed to change (by SQL convention) during statement execution. It will be understood by persons skilled in the art that other means of implementing the decision cache are possible.

It will be understood by persons skilled in the art that decision caching and/or other runtime performance enhancements of RDBMS 10 will generally need to be reflected in processing exits 86, where employed.

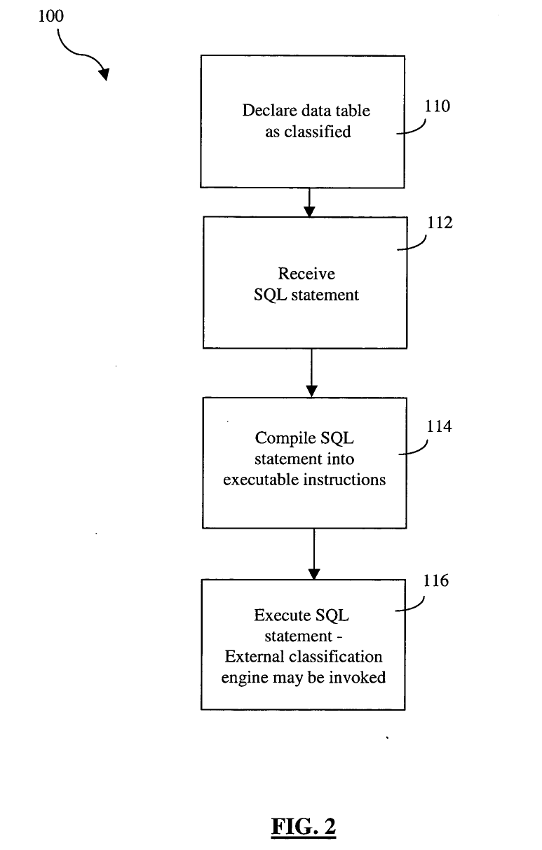

Referring to FIG. 2, a flowchart illustrating steps in a method of providing classification security in a database management system in an embodiment of the present invention is shown generally as 100.

At step 110, at least one data table (e.g. data table 52 of FIG. 1) is declared as classified. In declaring the data table as classified, the data table is associated with an external classification engine (e.g. external classification engine 84 of FIG. 1), and at least one classification column in the data table is identified. Data values stored in the identified classification columns can be used by the external classification engine to derive a classification level for a given row of the data table. For example, the classification column(s) may contain the label for the row stored directly in the data table, or they may contain data that is used by the external classification engine to derive the classification level for the row through a column mapping scheme.

At step 112, a request is received (e.g. by SQL compiler module 80 of FIG. 1) in the form of an SQL statement, where access to one or more rows of the classified data table may be required.

At step 114, the SQL statement is compiled into executable form and passed to a runtime module (e.g. SQL runtime module 82 of FIG. 1) for further processing. The executable form of the SQL statement includes added instructions (i.e. logic) for invoking the external classification engine. In one embodiment of the invention, the added instructions take the form of an access evaluation operator.

When the executable form of the SQL statement is executed, as at step 116 by the runtime module, for each row affected by the statement, an indicator of whether data stored in the respective row is eligible for access by the requester is retrieved from the external classification engine. The external classification engine is called through a well-defined user exit (e.g. of processing exits 86 of FIG. 1), passing on the row label (where the row label is not stored in the table, the values in one or more classification columns of the row from which the row label may be derived), the nature of the access (e.g. read/write), and authorization IDs or other authorization-related data available (e.g. the statement authorization ID, the session authorization ID and the system authorization ID, etc.) as arguments to the input classification parameters, for example. The external classification engine can use all or a subset of the authorization information to derive a requester classification depending on the particular implementation of the external classification engine. Alternatively, a user or requestor classification may be obtained from some other engine or source, for example. Similarly, it will use the values of the classification columns to derive a row label, whether directly from the values or via a mapping of the values to a classification, depending on the particular implementation of the external classification engine.

The external classification engine will then generate a “yes/no” indicator of whether data stored in the respective row should be made accessible to the requestor for each row, and return this indicator through the user exit to the associated caller (e.g. the executing SQL statement).

Data can then be retrieved from the data table in accordance with the indicator returned by the external classification engine. If the indicator for a particular row had a value of “no”, then the respective row should be discarded, and skipped without retrieving the data. If the indicator for a particular row had a value of “yes”, then the respective row can be further considered, and depending on the remaining instructions of the SQL statement, data from that row may be retrieved from the data table.

Optionally, in order to improve performance, prior to calling the external classification engine, a decision cache may be checked by the processing exit to determine whether an indicator was returned for the same set of arguments for the relevant classification parameters, so that the external classification engine need not be called in that instance if the indicator is already contained in the decision cache.

In another aspect of the invention, the RDBMS can also interact with the external classification engine in a number of ways to handle situations where new rows are inserted into (or existing rows are modified in) a classified data table. For example, for a classified data table, if a new label value is provided in a request that inserts/changes the data in a row, the external engine is called to validate the value and determine whether the current requester is allowed to perform the action. If a new label value is not provided in the request, the external classification engine is called to provide one, as well as confirm that the requester can perform the action. In both cases, the same classification arguments are passed and a response of a “yes/no” indicator for the row is expected from the external classification engine. In cases where column mapping is not, being used, classification column values may be returned from the external classification engine to be inserted into the classified table (in place of the existing values which may be the same or different).

While the present invention has been described in the context of requests in the form of SQL statements, it will be understood by persons skilled in the art that obvious modifications may be made to accommodate requests for access to the data in a database in other forms, which is intended to be within the scope of the present invention.

It will also be understood by persons skilled in the art that the term “requestor classification” may be defined broadly and need not refer to a single entity. For example, in addition to individual users, a common requestor classification may be defined for multiple individuals belonging to a defined group.

In variant embodiments of the present invention, instructions for performing a method in accordance with an embodiment of the present invention or any steps thereof may be provided on computer-readable media. Such computer-readable media is also intended to include network transmission media.

The present invention has been described with reference to particular embodiments. However, it will be understood by persons skilled in the art that a number of other variations or modifications are possible without departing from the scope of the invention as defined in the appended claims.

1. For a data processing system comprising a database, the database comprising classified table elements, the data processing system coupled to a classification engine adapted to provide indicators of approval or non-approval to permit, for a request associated with a requester, access to contents of the classified table elements, a method for retrieving data from the classified table elements, the method comprising the steps of:
receiving the request, from the requestor, to access the contents of the classified table elements;
for each classified table element, asking the classification engine to provide an indication of whether the requestor associated with the request is to be permitted access to the contents of the respective classified table element; and
accessing the contents of each classified table element for which an approval indicator is received from the classification engine, the approval indicator indicating that the requester is permitted to access the contents of the respective classified table element;
wherein the asking step comprises sending the request to the classification engine coupled to the data processing system.

2. The method of claim 1, further comprising the steps of:
providing, to the requester, access to the contents of each classified table element for which an approval indicator is received; and,
denying, to the requester, access to the contents of each classified table element for which a non-approval indicator is received from the classification engine, the non-approval indicator indicating that the requester is not permitted to access the contents of the respective classified table element.

3. The method of claim 1, wherein:
the classified table elements are included in a classified table contained in the database;
each classified table element is associated with a respective classification label; and
the classification engine uses the classification label for each classified table element and a classification associated with the requestor in determining whether to provide the approval indicator and whether to provide the non-approval indicator for the respective classified table element.

4. The method of claim 3, wherein the classified table element is a classified table row.

5. The method of claim 4, further comprising the step of compiling the request received at the receiving step into a plurality of executable instructions, the executable instructions comprising added instructions for invoking the classification engine such that for each row of the classified table, arguments for at least one classification parameter are passed to the classification engine for use in generating one of the approval indicator and non-approval indicator for the respective row, where the arguments comprise both data stored in one or more classification columns of the table and data used to determine the classification associated with the requester.

6. The method of claim 5, wherein the classification engine is adapted to generate the indicators using a classification level derived by the classification engine for each row, the classification level being derived from data stored in the at least one classification column of each respective row in accordance with a column mapping scheme.

7. The method of claim 1, wherein in the asking step, the classification engine is invoked through at least one processing exit in the data processing system.

8. The method of claim 1, further comprising, before the asking step, the step of checking, for each classified table element, whether a decision cache contains one of an approval indicator and non-approval indicator associated therewith, and wherein the asking step is performed only when neither indicator is contained in said decision cache.

9. A data processing system comprising a database, the database comprising classified table elements, the data processing system coupled to a classification engine adapted to provide indicators of approval or non-approval to permit, for a request associated with a requestor, access to contents of the classified table elements, the data processing system comprising one or more modules programmed to perform the steps of:
receiving the request, from the requester, to access the contents of the classified table elements;
for each classified table element, asking the classification engine to provide an indication of whether the requestor associated with the request is to be permitted access to the contents of the respective classified table element; and
accessing the contents of each classified table element for which an approval indicator is received from the classification engine, the approval indicator indicating that the requestor is permitted to access the contents of the respective classified table element;
wherein the asking step comprises sending the request to the classification engine coupled to the data processing system.

10. The data processing system of claim 9, wherein the one or more modules are further programmed to perform the steps of:
providing, to the requestor, access to the contents of each classified table element for which an approval indicator is received; and,
denying, to the requester, the copy of the accessed contents of each classified table element for which a non-approval indicator is received from the classification engine, the non-approval indicator indicating that the requestor is not permitted to access the contents of the respective classified table element.

11. The data processing system of claim 9, wherein:
the classified table elements are included in a classified table contained in the database;
each classified table element is associated with a respective classification label; and
the classification engine uses the classification label for each classified table element and a classification associated with the requestor in determining whether to provide the approval indicator and whether to provide the non-approval indicator for the respective classified table element.

12. The data processing system of claim 11, wherein the classified table element is a classified table row.

13. The data processing system of claim 12, wherein the one or more modules are further programmed to perform the step of compiling the request received at the receiving step into a plurality of executable instructions, the executable instructions comprising added instructions for invoking the classification engine such that for each row of the classified table, arguments for at least one classification parameter are passed to the classification engine for use in generating one of the approval indicator and non-approval indicator for the respective row, where the arguments comprise both data stored in one or more classification columns and data used to determine the classification associated with the requestor.

14. The data processing system of claim 12, wherein the classification engine is adapted to generate the indicators using a classification level derived by the classification engine for each row, the classification level being derived from data stored in the at least one classification column of each respective row in accordance with a column mapping scheme.

15. The data processing system of claim 9, wherein in the asking step, the classification engine is invoked through at least one processing exit in the data processing system.

16. The data processing system of claim 9, wherein the one or more modules are further programmed to perform, before the asking step, the step of checking, for each classified table element, whether a decision cache contains one of an approval indicator and non-approval indicator associated therewith, and wherein the asking step is performed only when neither indicator is contained in said decision cache.

17. For a data processing system comprising a database, the database comprising classified table elements, the data processing system coupled to a classification engine adapted to provide indicators of approval or non-approval to permit, for a request associated with a requestor, access to contents of the classified table elements, a computer-readable medium containing instructions for perform a method for retrieving data from the classified table elements, the method comprising the steps of:
receiving the request, from the requestor, to access the contents of the classified table elements;
for each classified table element, asking the classification engine to provide an indication of whether the requestor associated with the request is to be permitted access to the contents of the respective classified table element; and
accessing the contents of each classified table element for which an approval indicator is received from the classification engine, the approval indicator indicating that the requestor is permitted to access the contents of the respective classified table element;
wherein the asking step comprises sending the request to the classification engine coupled to the data processing system.

18. The computer-readable medium of claim 17, the method further comprising the steps of:
providing, to the requester, access to the contents of each classified table element for which an approval indicator is received; and,
denying, to the requestor, access to the contents of each classified table element for which a non-approval indicator is received from the classification engine, the non-approval indicator indicating that the requestor is not permitted to access the contents of the respective classified table element.

19. The computer-readable medium of claim 17, wherein:
the classified table elements are included in a classified table contained in the database;
each classified table element is associated with a respective classification label; and
the classification engine uses the classification label for each classified table element and a classification associated with the requestor in determining whether to provide the approval indicator and whether to provide the non-approval indicator for the respective classified table element.

20. The computer-readable medium of claim 19, wherein the classified table element is a classified table row.

21. The computer-readable medium of claim 20, the method further comprising the step of compiling the request received at the receiving step into a plurality of executable instructions, the executable instructions comprising added instructions for invoking the classification engine such that for each row of the classified table, arguments for at least one classification parameter are passed to the classification engine for use in generating one of the approval indicator and non-approval indicator for the respective row, where the arguments comprise both data stored in one or more classification columns of the table and data used to determine the classification associated with the requestor.

22. The computer-readable medium of claim 21, wherein the classification engine is adapted to generate the indicators using a classification level derived by the classification engine for each row, the classification level being derived from data stored in the at least one classification column of each respective row in accordance with a column mapping scheme.

23. The computer-readable medium of claim 17, wherein in the asking step, the classification engine is invoked through at least one processing exit in the data processing system.

24. The computer-readable medium of claim 17, further comprising, before the asking step, the step of checking, for each classified table element, whether a decision cache contains one of an approval indicator and non-approval indicator associated therewith, and wherein the asking step is performed only when neither indicator is contained in said decision cache.
